(19) United States
(12) Patent Application Publication
(10) Pub. No.: US 2007/0160785 A1
(43) Pub. Date: Jul. 12, 2007

(54) Flexible bag construction for liquid packaging and bag in box container utilizing same

(75) Inventors: Joe Hsu, Irvine, CA (US); Rocklin Verespej, Lake Forest, CA (US)

Correspondence Address: THE WATSON INTELLECTUAL PROPERTY GROUP, PLC, 3133 HIGHLAND DRIVE, SUITE 200, HUDSONVILLE, MI, 49426, US

(73) Assignee: SCHOLLE CORPORATION

(21) Appl. No.: 11/328,918

(22) Filed: Jan. 6, 2006

(51) Int. Cl. B32B 27/32

(52) U.S. Cl. 428/35.2

(57) ABSTRACT

A flexible bag for liquid packaging comprising at least one flexible wall and a spout. The at least one flexible wall is sealed to define a substantially fluid tight cavity and includes a product contact layer comprising a CO-PET material, an outer layer, and a resilient layer positioned between the product contact layer and the outer layer. The product contact layer has a thickness of approximately 0.5 mils to 1.25 mils. Further, the product contact layer is less than approximately one third of the thickness of the flexible wall. The spout has a flange and an opening. The flange of the spout attached to the flexible wall in a substantially fluid tight configuration.

### BACKGROUND OF THE INVENTION

1. Field of the Invention

The invention relates in general to flexible bags for liquid packaging, and more particularly to a flexible bag construction suitable for liquid packaging (i.e. bag in box) which is formed from multiple layers and includes a CO-PET layer.

2. Background Art

Flexible bags and bag in box packaging is becoming an increasingly popular manner in which to transport and sell liquid materials. However, flexible bag materials can adversely affect the taste of liquid products contained within the flexible bag. One material which generally does not affect the taste of a liquid is a CO-PET material, such as PET-g, among others. A CO-PET based material, such as PET-g, is also advantageous because it is transparent, which provides a user with an unobstructed view of the contents of the flexible bag. Generally, flexible bags for liquids are typically translucent but lack the clarity necessary to have an unobstructed view of the contents therewithin.

While a CO-PET material would be quite desirable for use in flexible bags, especially for taste sensitive products, CO-PET is generally excessively brittle for use in association with flexible bags configured to carry liquids. Moreover, CO-PET is typically not well suited for the formation of seals. Further, the CO-PET lacks the required ductility necessary which may lead to stress cracking during transport.

It is an object of the invention to provide a flexible wall having a CO-PET as a product contact layer which is suitable for use in association with a flexible bag.

It is another object of the invention to provide a flexible bag for use with a bag in box container formed from a CO-PET material which is suitable for carrying liquid contents.

These objects as well as other objects of the present invention will become apparent in light of the present specification, claims, and drawings.

### SUMMARY OF THE INVENTION

The invention comprises a flexible bag for liquid packaging having at least one flexible wall and a spout. The at least one flexible wall is sealed to define a substantially fluid tight cavity and includes a product contact layer comprising a CO-PET material, an outer layer, and a resilient layer positioned between the product contact layer and the outer layer. The product contact layer has a thickness of approximately 0.5 mils to 1.25 mils. Further, the product contact layer is less than approximately one third of the thickness of the flexible wall. The spout has a flange and an opening. The flange of the spout attached to the flexible wall is a substantially fluid tight configuration.

In a preferred embodiment, the flexible wall is substantially transparent.

In another preferred embodiment, the product contact layer has a thickness of approximately 0.75 mils.

In yet another preferred embodiment, the outer layer comprises LLDPE and resilient layer comprises one of EMAC, ADMER and EVA.

In another embodiment, the flexible wall comprises a co-extrusion. Preferably, the outer layer comprises a thickness of approximately 1.5 mils.

In another embodiment, the resilient layer comprises a thickness of no more than approximately 1 mil.

In one embodiment, the flange of the spout is sealed to the outer layer of a portion of the flexible wall. In another embodiment, the flange of the spout is sealed to the inner layer of a portion of the flexible wall.

In another embodiment, the invention comprises a bag in box container. The container comprises a box and a flexible bag. The box has a plurality of panels and a spout opening. The flexible bag comprises at least one flexible wall sealed to form a cavity for the storage of a liquid. The flexible bag has a product contact layer of CO-PET. The product contact layer comprises a thickness of between 0.5 mils and 1.25 mils. The product contact layer comprises less than approximately one third of the thickness of the at least one flexible wall. A spout attached to the flexible wall.

In a preferred embodiment, the outer box further includes a viewing opening extending through one of the plurality of panels so as to provide a user with a view of the flexible bag.

In another embodiment, the flexible wall is substantially transparent. Preferably, the product contact layer has a thickness of approximately 0.75 mils. In certain embodiments, the CO-PET layer comprises a PET-g.

In another embodiment, the at least one flexible wall further includes a resilient layer and an outer layer, the resilient layer comprises one of EMAC, ADMER and EVA and the outer layer comprises an LLDPE.

Preferably, the flexible wall comprises a co-extrusion. In another preferred embodiment, the outer layer comprises a thickness of approximately 1.5 mils. In another embodiment, the resilient layer comprises a thickness of no more than approximately 1 mil.

In another embodiment, the flange of the spout is sealed to the outer layer of a portion of the flexible wall.

Preferably, the flange of the spout is sealed to the inner layer of a portion of the flexible wall.

In another aspect of the invention, the invention comprises a flexible wall material for the forming of a flexible bag. The flexible wall material comprises a product contact layer comprising CO-PET, a resilient layer positioned on the product contact layer, and an outer layer positioned on the resilient layer opposite of the product contact layer. The product contact layer has a thickness of approximately 0.5 mils to 1.25 mils. The product contact layer is less than approximately one third of the thickness of the flexible wall.

In a preferred embodiment, the resilient layer comprises one of EMAC, ADMER and EVA. Preferably, the resilient layer has a thickness which is less than 1 mil. In another embodiment, the outer layer comprises a LLDPE material.

Preferably, the outer layer has a thickness of approximately 1.5 mils.

In another aspect of the invention, the invention comprises a method of manufacturing a flexible bag. The method comprises the steps of (a) providing at least one flexible wall including a product contact layer which comprises CO-PET having a thickness of between 0.5 and 1.25 mils and wherein the product contact layer comprises less than approximately one third of the thickness of the at least one flexible wall; (b) sealing the at least one flexible wall to define a substantially fluid tight cavity; (c) cutting an opening into the at least one flexible wall to provide ingress into the cavity; (d) attaching a spout about the opening.

In a preferred embodiment, step of sealing comprises the step of forming a seal at a temperature in excess of 255° F. at a pressure of 80 psi. In another preferred embodiment, the step of sealing comprises the step of forming a seal at a temperature in excess of 265° F. at a pressure of 40 psi. Additionally, the at least one flexible wall further includes an outer layer and a resilient layer positioned between the product contact layer and the outer layer.

The invention further comprises a method of using a flexible bag comprising the steps of (a) providing a flexible bag comprising at least one flexible wall including a product contact layer which comprises CO-PET having a thickness of between 0.5 and 1.25 mils and wherein the product contact layer comprises less than approximately one third of the thickness of the at least one flexible wall which is sealed to define a substantially fluid tight cavity and a spout providing ingress into the cavity; and (b) filling the flexible bag with a liquid.

In a preferred embodiment, the method further comprises the step of placing the flexible bag in an outer box.

### BRIEF DESCRIPTION OF THE DRAWINGS

The invention will now be described with reference to the drawings wherein:

FIG. 1 of the drawings comprises a perspective view of a bag in box container of the present invention;

FIG. 2 of the drawings comprises a perspective view of a flexible bag of the present invention;

FIG. 3 of the drawings comprises a side-elevational view of the flexible bag of the present invention;

FIG. 4 of the drawings comprises a partial cross-sectional view of an embodiment of the flexible wall of the present invention; and

FIGS. 5a and 5b of the drawings comprises various embodiments of the spout of the flexible bag of the present invention.

### DETAILED DESCRIPTION OF THE DRAWINGS

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

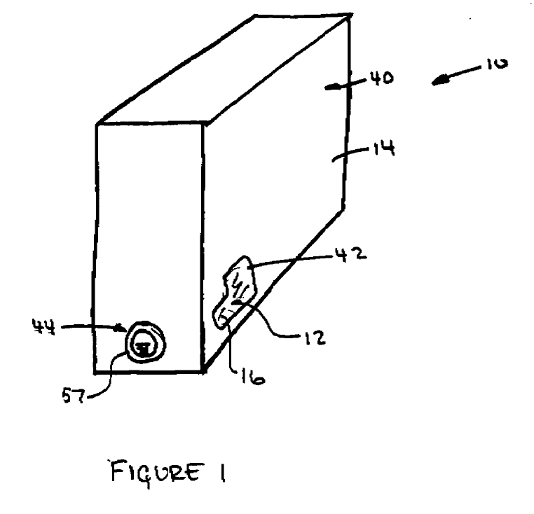

Referring now to the drawings and in particular to FIG. 1, bag in box container 10 comprises flexible bag 12, and outer box 14. As will be understood, the bag in box container is typically utilized for the storage and dispensing of liquids (and other flowable material). For example, wine is often stored, shipped, and dispensed in such bag in box packaging. In other embodiments, water, syrup and other liquids are contemplated for use. Among other difficulties, the weight and the flow characteristics of liquid exert significant pressure against the seals and the walls of such containers, especially during shipment and transport.

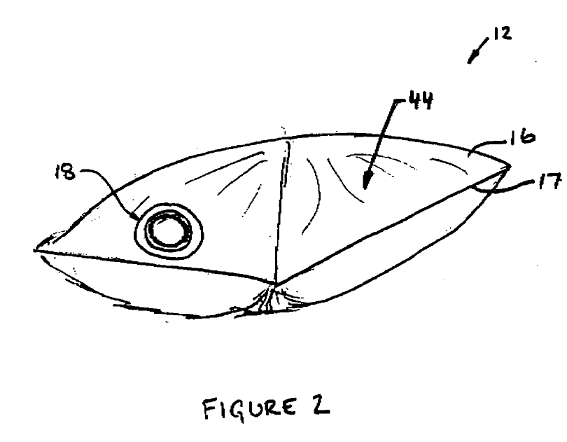

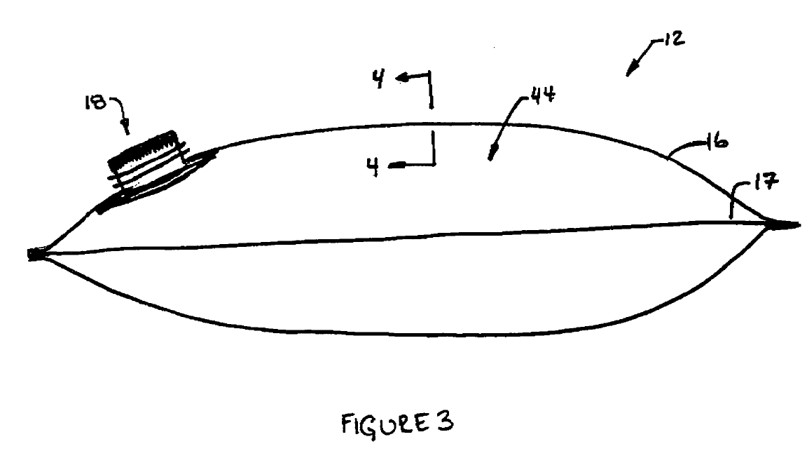

Flexible bag 12 is shown in FIGS. 2 and 3 as comprising at least one flexible wall, such as, 16, seals 17 and spout 18. The at least one flexible wall 16 and the seals 17 define cavity 44. In the embodiment shown, two flexible walls are utilized and seals extend about the perimeter of each of the flexible walls to define cavity 44. Such a container is commonly referred to as a pillow type container. In other embodiments, a single flexible wall may be utilized wherein the flexible wall is folded onto itself and three seals are used to define cavity 44. In yet other embodiments, three or more flexible walls may be utilized along with seals to define a cavity.

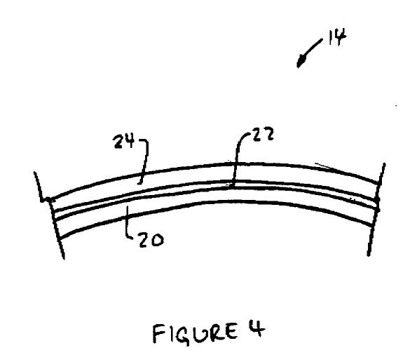

With reference to FIG. 4, flexible wall 16 comprises product contact layer 20, resilient layer 22, and outer layer 24. The flexible wall 16 is substantially transparent and allows for a substantially unobstructed view of the contents therein. The flexible wall is formed from at least three distinct layers which are co-extruded and/or laminated to each other. The combined layers have a thickness of approximately 1.9 mils to 3 mils, although thicker embodiments are contemplated.

Product contact layer comprise Polyethylene Terephthalate Copolymer, or CO-PET. While a CO-PET web is typically too brittle and generally incapable of countering the forces required for liquid transport, it has been found that CO-PET having a thickness of between approximately 0.5 mils and approximately 1.25 mils, and most preferably approximately 0.75 mils, has sufficient ductility for use in association with a flexible bag for liquid packaging. Furthermore, in the above configuration the product contact layer is no greater than approximately one third of the thickness of the flexible wall. In one embodiment, it is contemplated that the CO-PET comprises a PET-g material. PET-g is particularly useful due to it beneficial characteristics relative to food contact and its processability. Of course, other CO-PET materials in the foregoing configurations are likewise contemplated.

Resilient layer 22 provides an interface by which to couple the contact layer to the outer layer. Preferably, the resilient layer comprises one of ethylene-methyl acrylate copolymer (EMAC), ethylene vinyl acetate (EVA) and an adhesive resin, such as ADMER available from Mitsui Chemicals America, Inc of New York. The resilient layer comprises approximately less than 1 mil. The resilient layer provides an interface by which to couple the contact layer to the outer layer.

Outer layer 24 is positioned on the resilient layer opposing the product contact layer. The outer layer preferably comprises a material that is resistant to scratching and tearing, and which provides ductility to the flexible wall. In the embodiment shown, the outer layer comprises a linear low density polyethylene (LLDPE). In the embodiment shown, the outer layer comprises approximately 1.5 mils in thickness.

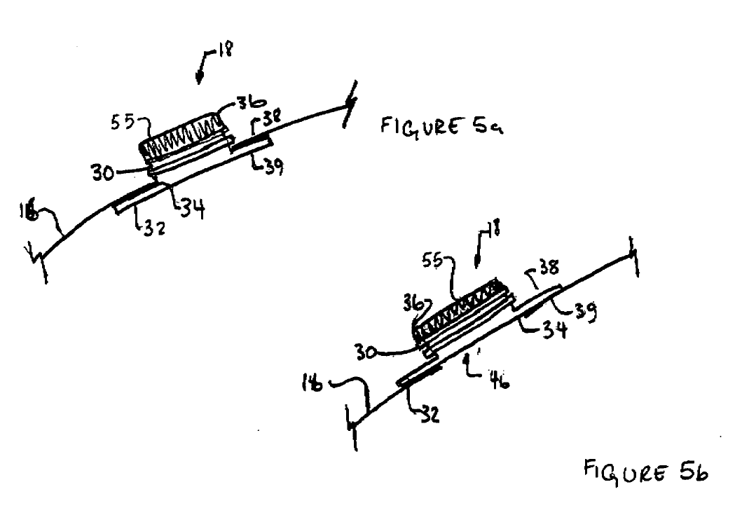

Spout 18 is shown in FIGS. 5a and 5b as comprising body 30 and base flange 32. Body 30 includes first end 34 and second end 36. A plurality of grasping flanges may be positioned on the outer surface of body 30 between first end 34 and second end 36. These grasping flanges facilitate grasping and retention of the flexible bag for filling and dispensing. The flange body includes opening 46 which provides ingress into cavity 44. Typically, the flexible wall includes an opening which is surrounded by spout 28. In certain embodiments, the spout may be attached to the flexible wall wherein a portion of the flexible wall between opening 46 and cavity 44 is pierced by a spigot or other fitment to provide fluid communication between opening 46 and cavity 44. The spout may be capped with a cap 55 or a fitment 57 (FIG. 1).

Flange 32 extends outwardly from the first end 34 and includes top surface 38 and bottom surface 39. In certain embodiments, as is shown in FIG. 5a, the top surface 38 of flange 32 may be sealed to the product contact layer 20 of flexible wall 16. In such an embodiment, the spout may comprise a material identical to that of the product contact layer, or compatible with the product contact layer. In another embodiment, as is shown in FIG. 56, the bottom surface 39 may be sealed to outer layer 24. Such a configuration may be utilized inasmuch as the product contact layer is typically not compatible with the materials from which the spout is typically formed.

In yet another embodiment, the spout may comprise a two part configuration. One such configuration is shown in co-pending PCT Patent Application No. PCT/US05/40156 entitled, “Oxygen Impermeable Bag-in-Box Container and Method of Making.” The entire specification of this application is incorporated herein by reference. Such a configuration is quite useful in the present invention due to the relative incompatibility of the product contact layer with the material from which spouts are typically formed.

Outer box 14 is shown in FIG. 1 as comprising a plurality of panels, such as panel 40, viewing opening 42 and spout opening 44. The panels 40 form a generally rectangular cubic configuration formed from a paperboard material. In certain embodiments, the paperboard may comprise a corrugated paperboard material. Spout opening 44 is provided generally at the base of one of the panels 40. The spout opening 44 generally has a shape mating configuration with spout 18 so as to retain the spout in a desired orientation at spout opening 44. Viewing opening 42 is provided on another of panels 40. Inasmuch as the flexible wall 16 are substantially transparent, the viewing opening 42 provides an opening by which a user can view the contents within the substantially transparent flexible bag 12.

To form the flexible bag, the flexible wall material is first formed. In certain embodiments, the flexible wall may be formed through a coextrusion process. In other embodiments, the flexible wall may be formed through a lamination process. Once formed, the flexible wall or walls are attached together by way of seals 17. To provide an effective seal which is resistant to fracture, the seals formed at a lower pressure (40 psi) are at a temperature above 260° F. at a lower pressure. Seals formed at a higher pressure (80 psi) are at a temperature above 255° F. Surprisingly, the strength of these seals greatly increases when formed at these temperature ranges.

Once the flexible walls are sealed to form the flexible bag, spout 18 is attached to the flexible bag (surrounding an opening formed therethrough). In certain embodiments, flange 32 of spout 18 may be attached to either the product contact layer 20 or the outer layer 24. In another embodiment, the flexible wall may be sandwiched therebetween.

Once the flexible bag is completed, the flexible bag can be filled by any number of different fillers. For example, the flexible bag can be filled with wine, or another liquid. Once filled, the spout is capped with a cap or a fitment. Next, the flexible bag 12 is placed into outer box 14. Inasmuch as the flexible bag is substantially transparent, the contents within the flexible bag can be viewed through the viewing opening in the outer box.

The flexible bag of the present invention can be formed from a CO-PET material which is quite advantageous inasmuch as it does not generally impart flavor to the contents of the flexible bag. Moreover, a flexible bag formed in the foregoing manner provides a substantially transparent container of sufficient strength for the transport of liquid contents which further provides a clear view of the contents within the flexible bag.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A flexible bag for liquid packaging comprising:
at least one flexible wall sealed to define a substantially fluid tight cavity, the at least one flexible wall having
a product contact layer comprising a CO-PET material;
an outer layer; and
a resilient layer positioned between the product contact layer and the outer layer;
wherein the product contact layer has a thickness of approximately 0.5 mils to 1.25 mils and wherein the product contact layer is less than approximately one third of the thickness of the flexible wall; and
a spout having a flange and an opening, the flange of the spout attached to the flexible wall in a substantially fluid tight configuration.

2. The flexible bag of claim 1 wherein the flexible wall is substantially transparent.

3. The flexible bag of claim 1 wherein the product contact layer has a thickness of approximately 0.75 mils.

4. The flexible bag of claim 1 wherein the CO-PET material comprises a PET-g material.

5. The flexible bag of claim 1 wherein the outer layer comprises LLDPE and resilient layer comprises one of EMAC, ADMER and EVA.

6. The flexible bag of claim 1 wherein the flexible wall comprises a co-extrusion.

7. The flexible bag of claim 1 wherein the outer layer comprises a thickness of approximately 1.5 mils.

8. The flexible bag of claim 1 wherein the resilient layer comprises a thickness of no more than approximately 1 mil.

9. The flexible bag of claim 1 wherein the flange of the spout is sealed to the outer layer of a portion of the flexible wall.

10. The flexible bag of claim 1 wherein the flange of the spout is sealed to the inner layer of a portion of the flexible wall.

11. A bag in box container for liquids comprising:
a box having a plurality of panels and a spout opening; and
a flexible bag comprising at least one flexible wall sealed to form a cavity for the storage of a liquid, the flexible bag having a product contact layer of CO-PET wherein the product contact layer comprises a thickness of between 0.5 mils and 1.25 mils, and wherein the product contact layer comprises less than approximately one third of the thickness of the at least one flexible wall, and, a spout attached to the flexible wall.

12. The bag in box container of claim 11 wherein the outer box further includes a viewing opening extending through one of the plurality of panels so as to provide a user with a view of the flexible bag.

13. The bag in box container of claim 11 wherein the flexible wall is substantially transparent.

14. The bag in box container of claim 11 wherein the product contact layer has a thickness of approximately 0.75 mils.

15. The bag in box container of claim 11 wherein the at least one flexible wall further includes a resilient layer and an outer layer, the resilient layer comprises one of EMAC, ADMER and EVA and the outer layer comprises an LLDPE.

16. The bag in box container of claim 15 wherein the flexible wall comprises a co-extrusion.

17. The bag in box container of claim 15 wherein the outer layer comprises a thickness of approximately 1.5 mils.

18. The bag in box container of claim 15 wherein the resilient layer comprises a thickness of no more than approximately 1 mil.

19. The bag in box container of claim 11 wherein the flange of the spout is sealed to the outer layer of a portion of the flexible wall.

20. The bag in box container of claim 11 wherein the flange of the spout is sealed to the inner layer of a portion of the flexible wall.

21. The bag in box container of claim 11 wherein the CO-PET material comprises a PET-g material.

22. A flexible wall material for the forming of a flexible bag comprising:
a product contact layer comprising CO-PET;
a resilient layer positioned on the product contact layer; and
an outer layer positioned on the resilient layer opposite of the product contact layer,
wherein the product contact layer has a thickness of approximately 0.5 mils to 1.25 mils and wherein the product contact layer is less than approximately one third of the thickness of the flexible wall.

23. The flexible wall material of claim 22 wherein the resilient layer comprises one of EMAC, ADMER and EVA.

24. The flexible wall material of claim 23 wherein the resilient layer has a thickness which is less than 1 mil.

25. The flexible wall material of claim 22 wherein the outer layer comprises a LLDPE material.

26. The flexible wall material of claim 25 wherein the outer layer has a thickness of approximately 1.5 mils.

27. A method of manufacturing a flexible bag comprising the steps of:
providing at least one flexible wall including a product contact layer which comprises CO-PET having a thickness of between 0.5 and 1.25 mils and wherein the product contact layer comprises less than approximately one third of the thickness of the at least one flexible wall;
sealing the at least one flexible wall to define a substantially fluid tight cavity;
cutting an opening into the at least one flexible wall to provide ingress into the cavity;
attaching a spout about the opening.

28. The method of claim 27 wherein the at least one flexible wall further includes an outer layer and a resilient layer positioned between the product contact layer and the outer layer.

29. The method of claim 27 wherein the step of sealing comprises the step of forming a seal at a temperature in excess of 255° F. at a pressure of 80 psi.

30. The method of claim 27 wherein the step of sealing comprises the step of forming a seal at a temperature in excess of 265° F. at a pressure of 40 psi.
